(19) United States
(12) Patent Application Publication
(10) Pub. No.: US 2018/0242564 A1
(43) Pub. Date: Aug. 30, 2018

(54) Modular Spear

(71) Applicant: Steven P. DeBauch, Gillett, WI (US)

(72) Inventor: Steven P. DeBauch, Gillett, WI (US)

(21) Appl. No.: 15/907,244

(22) Filed: Feb. 27, 2018

Related U.S. Application Data
(60) Provisional application No. 62/464,274, filed on Feb. 27, 2017.

(51) Int. Cl. A01K 81/04; A01M 27/00; F16B 7/06; F16B 7/18

(52) U.S. Cl. CPC A01K 81/04; F16B 7/182; F16B 7/06; A01M 27/00

(57) ABSTRACT

A modular spear that has three interchangeable sections, namely, a spear tip, a spear shaft, and a tail end, allowing the spear to be adapted for many situations. The spear shaft has an elongated body into which a first receiving cavity and a second receiving cavity are terminally are bored; the first receiving cavity being positioned opposite the second receiving cavity along the elongated body. Furthermore, the spear shaft has a first fastener assembly and a second fastener assembly for securing the spear tip and the tail end to the spear shaft. The first fastener assembly is positioned about the first receiving cavity, while the second fastener assembly is positioned about the second receiving cavity. The spear tip is positioned through the first fastener assembly and into the first receiving cavity. Meanwhile, the tail end is positioned through the second fastener assembly and into the second receiving cavity.

The current application claims a priority to the U.S. Provisional Patent application Ser. No. 62/464,274 filed on Feb. 27, 2017.

### FIELD OF THE INVENTION

The present invention relates generally to the field of hunting tools. More specifically, the present invention is a modular spear having three interchangeable sections.

### BACKGROUND OF THE INVENTION

Bow fishing has grown in popularity over the years due to a number of reasons, such as increased exposure to the sport and the growing populations of invasive species like rough fish. To legally partake in the sport of bow fishing, one must tether their arrows before firing them into the water. This is to prevent fish from escaping, taking along with them the arrow, which could pose an ecological threat to the waterways, danger to other humans or animals, etc. While the popularity of bow fishing has increased, it is still not inclusive to all parties, namely, disabled people or people who cannot otherwise operate a bow. For example, someone missing a limb would find difficulty in notching an arrow and firing a bow. Thus, a single-handed instrument would be ideal for such handicapped individuals wishing to partake in the sport of bow fishing. A tethered spear would provide the ideal single-handed instrument for achieving a feeling similar to that of using a bow.

The spear is a hand thrown multi-use tool that can be used to harvest fish, alligators, and any legal big game animals. When using a spear for hunting fish, alligators or crocodiles, spear game law requires the tool to be tethered or have a line attached to it. The user then has the option to retrieve the quarry by hand with the tether or use a fishing pole/reel for added sport. If so desired, a floating device can also be attached to the tether (typical when hunting alligators and crocodiles), etc. When used as a game spear the user could attach a tracking string to aid in the recovery of game or recovery of the spear. In some instances, a standard lighted component/receiver could be attached to the back end of the spear as a means of tracking of game and or recovery of the spear. While it is evident that a means of attachment for a tether, or other peripheral, are helpful or necessary in many hunting situations, many spears are not adapted for such attachments. Furthermore, there is not an easy way for modifying a spear in order to accommodate the attachment of a tether.

When spear hunting it can be common for the spear tip to become damaged, or broken completely, thus requiring replacement. Replacing a broken or damaged spear tip is an arduous process and typically involves the use of an adhesive which takes time to set, thus preventing spears from being fixed in a practical manner while out hunting. Furthermore, in extreme cases it may be impossible for the spear tip alone to be replaced, thus adding on to the cost incurred by the user.

Therefore, it is an object of the present invention to provide a modular spear having three modular sections. The present invention includes a spear tip, a spear shaft, and a tail end, wherein the spear tip and the tail end are removably attached to opposite ends of the spear shaft. This allows one or more pieces of the present invention to be replaced independent of each other, thus leading to less costs incurred by the user and time saved when performing modifications or replacements. The spear shaft includes a first fastener assembly and a second fastener assembly that allow for the secure attachment of the spear tip and the tail end. Furthermore, the first fastener assembly and the second fastener assembly allow for the quick attachment or removal of the spear tip and the tail end to or from the spear shaft. This allows the user to switch tips for the correct application in an efficient manner (e.g. transitioning from a practice head to a hunting broad head to a spearfishing head).

With the growing population of invasive rough fish (and other species of fish) and the growing popularity of bow fishing, the present invention aids in adding new dimensions to the sport. Users can experience the past while aiding in the control of invasive rough fish (and other overpopulated species). The present invention also allows individuals with physical limitations to target rough fish. While these limitations prevent them from being able to draw and shoot archery equipment (the most common tool for harvesting rough fish), the present invention can be operated with one hand making it more accessible to a greater number of people. Rough fish are here to stay, so we might as well take every advantage of the resource.

### BRIEF DESCRIPTION OF THE DRAWINGS

FIG. 1 is a perspective view of the present invention, wherein the spear tip and the tail end are detached from the spear shaft.

FIG. 2 is a perspective view of the present invention, wherein the spear tip and the tail end are attached to the spear shaft.

FIG. 3 is a cross sectional view showing the first receiving cavity and the second receiving cavity traversing into the elongated body.

FIG. 4 is a cross sectional view showing the spear tip being positioned through the first fastener assembly into the first receiving cavity and the tail end being positioned through the second fastener assembly into the second receiving cavity.

FIG. 5 is an exploded detail view of the first fastener assembly.

FIG. 6 is an exploded detail view of the second fastener assembly.

FIG. 7 is a detail view of the spear tip being attached to the spear shaft.

FIG. 8 is a detail view of the tail end being attached to the spear shaft.

FIG. 9 is a detail view showing the coupling between the end cap and the ring.

FIG. 10 is a perspective view of the present invention, wherein the elongated body is tapered towards the first fastener assembly and the second fastener assembly.

FIG. 11 is a detail view showing the line connector, wherein the ring is coupled to the end cap via a swivel component.

### DETAIL DESCRIPTIONS OF THE INVENTION

All illustrations of the drawings are for the purpose of describing selected versions of the present invention and are not intended to limit the scope of the present invention.

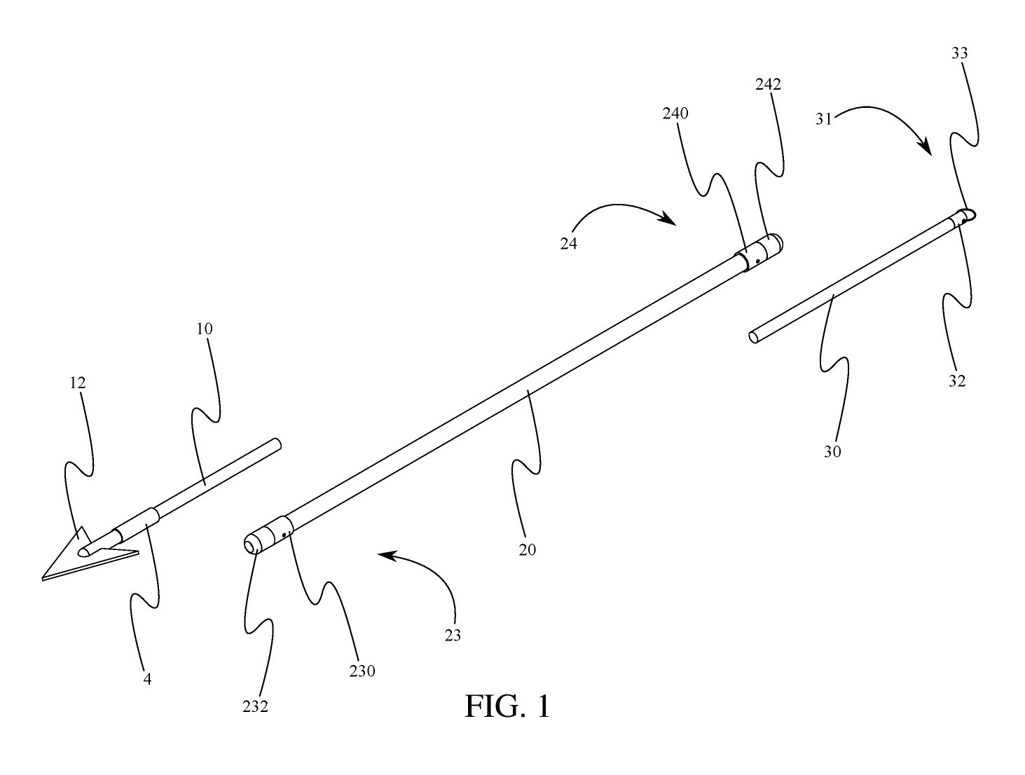

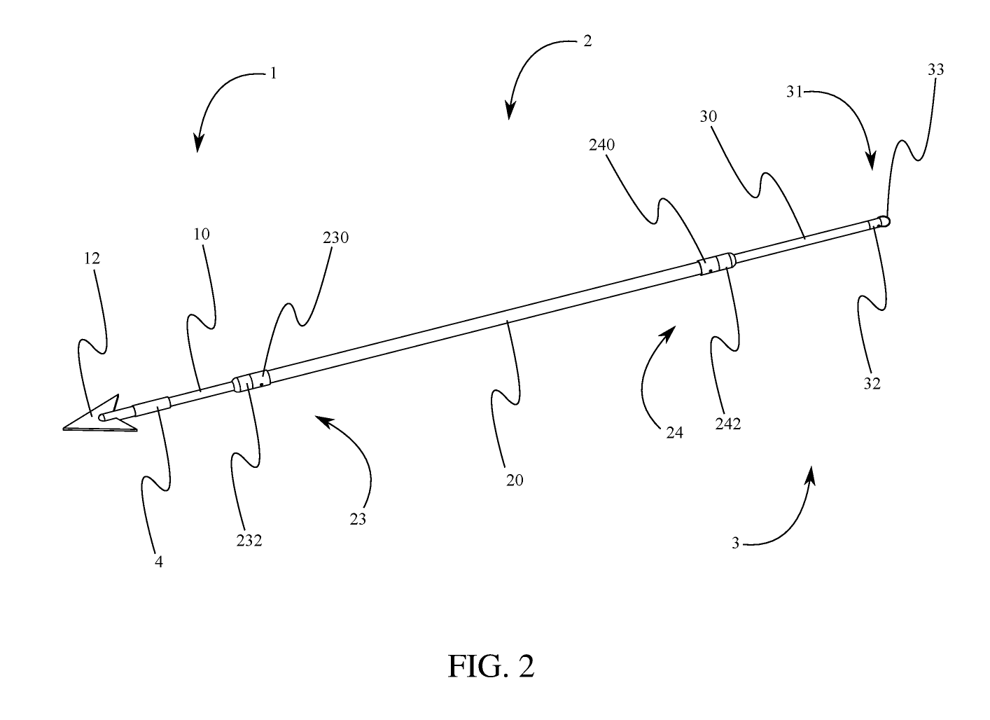

The present invention is a modular spear having three interchangeable sections. More specifically, the present invention comprises a spear tip 1, a spear shaft 2, and a tail end 3. In reference to FIG. 1-2, the spear tip 1 and the tail end 3 are removably attached to opposite ends of the spear shaft 2, such that the spear tip 1 and the tail end 3 can be removed or replaced as needed. This allows for the present invention to be modified on the go, which provides a more adaptable hunting instrument and also allows broken pieces to be more easily replaced.

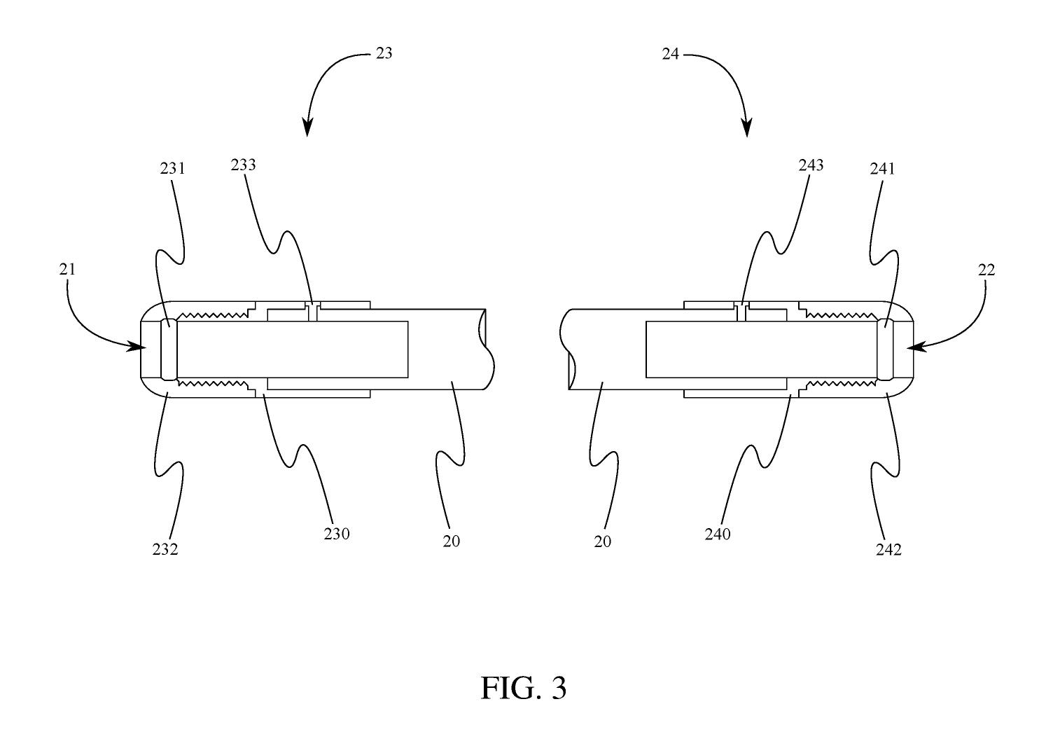

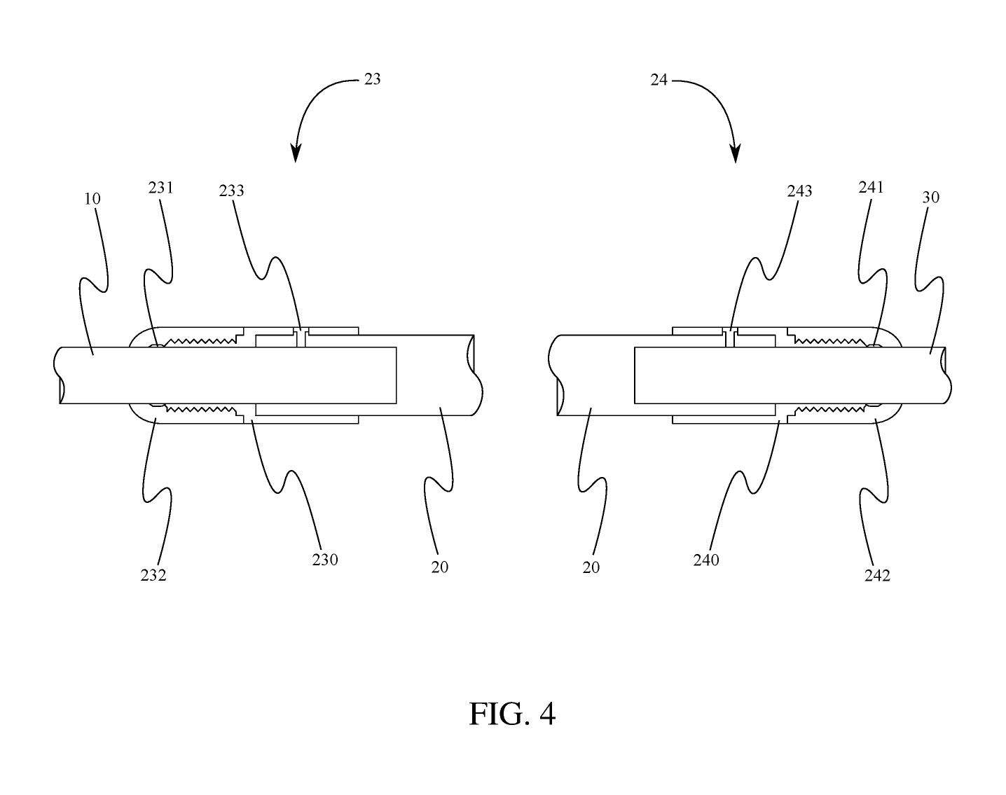

The spear shaft 2 accounts for a majority of the length of the present invention, wherein the spear shaft 2 comprises an elongated body 20, a first receiving cavity 21, and a second receiving cavity 22. The elongated body 20 provides the main body of the spear shaft 2 and is the portion of the present invention that is held by a user when throwing the present invention. The first receiving cavity 21 and the second receiving cavity 22 terminally traverse into the elongated body 20, wherein the first receiving cavity 21 and the second receiving cavity 22 are positioned opposite each other along the elongated body 20, as depicted in FIG. 3. The first receiving cavity 21 and the second receiving cavity 22 provide mounting points to the spear shaft 2, into which the spear tip 1 and the tail end 3 are positioned, respectively, as depicted in FIG. 4.

In reference to FIG. 2-3, in some embodiments of the present invention, the spear shaft 2 further comprises a first fastener assembly 23 and a second fastener assembly 24. The first fastener assembly 23 and the second fastener assembly 24 are terminally connected to the elongated body 20. The first fastener assembly 23 is used to secure the spear tip 1 within the first receiving cavity 21, while the second fastener assembly 24 is used to secure the tail end 3 within the second receiving cavity 22. As such, the first fastener assembly 23 is positioned about the first receiving cavity 21. Meanwhile, the second fastener assembly 24 is positioned about the second receiving cavity 22. In reference to FIG. 4, to secure the spear tip 1 to the spear shaft 2, the spear tip 1 is positioned through the first fastener assembly 23 into the first receiving cavity 21, wherein the first fastener assembly 23 is then tightened. Similarly, to secure the tail end 3 to the spear shaft 2, the tail end 3 is positioned through the second fastener assembly 24 into the second receiving cavity 22, wherein the second fastener assembly 24 is then tightened

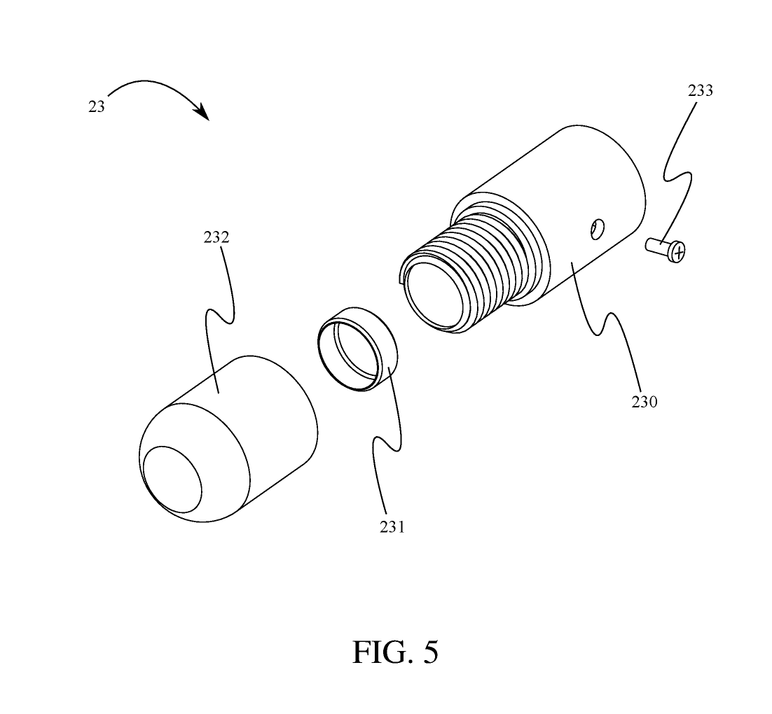

In reference to FIG. 3-5, in some embodiments of the present invention, the first fastener assembly 23 comprises a first receiving fitting 230, a first compression fastener 232, a first ferrule 231, and a first set screw 233. The first receiving fitting 230 is connected around the elongated body 20 (and the first receiving cavity 21), while the first compression fastener 232 is threadedly engaged with the first receiving fitting 230 opposite the second fastener assembly 24. The first ferrule 231 is positioned in between the first receiving fitting 230 and the first compression fastener 232, wherein the first ferrule 231 is deformed in order to impart a force on the spear tip 1 as the first compression fastener 232 is tightened about the first receiving fitting 230. Meanwhile, the first set screw 233 traverses through the first receiving fitting 230 and the elongated body 20, wherein the first set screw 233 engages with the spear tip 1 to further secure the spear tip 1 within the first receiving cavity 21.

To attach the spear tip 1 to the spear shaft 2, the first set screw 233 and the first compression fastener 232 are loosened or removed entirely. The first set screw 233 may be fully removed from the threaded hole bored through the first receiving fitting 230 and the elongated body 20, or the first set screw 233 may be loosened, such that the first set screw 233 does not obstruct the full passage of the first the spear tip 1 into the first receiving cavity 21. The first compression fastener 232 may be fully detached from the first receiving fitting 230, or the first compression fastener 232 may be loosened, such that the first compressions fitting is relaxed from the first receiving fitting 230 and the first ferrule 231 is decompressed. With the first set screw 233 and the first compression fastener 232 either loosened or removed, the spear shaft 2 is positioned through each of the first compression fastener 232, the first ferrule 231, and the first receiving fitting 230 into the first receiving cavity 21. The first set screw 233 and the first compression fastener 232 are then tightened to secure the spear tip 1 to the spear shaft 2.

In such embodiments, the first receiving fitting 230, the first ferrule 231, and the first compression fastener 232 form a compression fitting. As the first compression fastener 232 is tightened onto the first receiving fitting 230, the ends of the first ferrule 231 are clamped around the spear tip 1, thereby securing the spear tip 1 to the spear shaft 2. Meanwhile, the addition of the first set screw 233 provides a dual-means for securing the spear tip 1 to the spear shaft 2. As the first set screw 233 is tightened, the first set screw 233 laterally engages the spear tip 1, wherein the first set screw 233 applies a lateral force on the spear tip 1 that clamps the spear tip 1 between the first set screw 233 and the interior wall of the elongated body 20. The dual-means of securing the spear tip 1 to the spear shaft 2 provides a failsafe in the event that either the first set screw 233 or the first fastener assembly 23 fails during implementation of the present invention.

To detach the spear tip 1 from the spear shaft 2, the first set screw 233 is loosened or removed entirely. Similarly, the first compression fastener 232 is loosened or detached from the first receiving fitting 230 entirely, such that the first compression fastener 232 is able to freely slide along the spear tip 1. With the first set screw 233 and the first compression fastener 232 either loosened or removed, the spear shaft 2 is pulled out of the first receiving cavity 21 and out through each of the first receiving fitting 230, the first ferrule 231, and the first compression fastener 232.

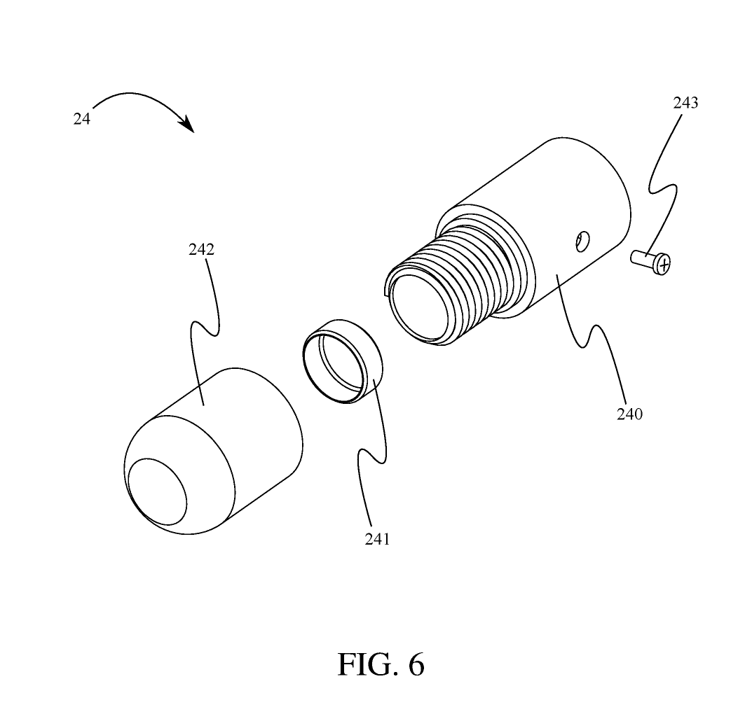

In reference to FIG. 3-4 and FIG. 6, in some embodiments of the present invention, the second fastener assembly 24 comprises a second receiving fitting 240, a second compression fastener 242, a second ferrule 241, and a second set screw 243. The second receiving fitting 240 is connected around the elongated body 20 (and the second receiving cavity 22), while the second compression fastener 242 is threadedly engaged with the second receiving fitting 240 opposite the first fastener assembly 23. The second ferrule 241 is positioned in between the second receiving fitting 240 and the second compression fastener 242, wherein the second ferrule 241 is deformed in order to impart a force on the tail end 3 as the second compression fastener 242 is tightened about the second receiving fitting 240. Meanwhile, the second set screw 243 traverses through the second receiving fitting 240 and the elongated body 20, wherein the second set screw 243 engages with the tail end 3 to further secure the tail end 3 within the second receiving cavity 22.

To attach the tail end 3 to the spear shaft 2, the second set screw 243 and the second compression fastener 242 are loosened or removed entirely. The second set screw 243 may be fully removed from the threaded hole bored through the second receiving fitting 240 and the elongated body 20, or the second set screw 243 may be loosened, such that the second set screw 243 does not obstruct the full passage of the second the tail end 3 into the second receiving cavity 22. The second compression fastener 242 may be fully detached from the second receiving fitting 240, or the second compression fastener 242 may be loosened, such that the second compressions fitting is relaxed from the second receiving fitting 240 and the second ferrule 241 is decompressed. With the second set screw 243 and the second compression fastener 242 either loosened or removed, the spear shaft 2 is positioned through each of the second compression fastener 242, the second ferrule 241, and the second receiving fitting 240 into the second receiving cavity 22. The second set screw 243 and the second compression fastener 242 are then tightened to secure the tail end 3 to the spear shaft 2.

In such embodiments, the second receiving fitting 240, the second ferrule 241, and the second compression fastener 242 form a compression fitting. As the second compression fastener 242 is tightened onto the second receiving fitting 240, the ends of the second ferrule 241 are clamped around the tail end 3, thereby securing the tail end 3 to the spear shaft 2. Meanwhile, the addition of the second set screw 243 provides a dual-means for securing the tail end 3 to the spear shaft 2. As the second set screw 243 is tightened, the second set screw 243 laterally engages the tail end 3, wherein the second set screw 243 applies a lateral force on the tail end 3 that clamps the tail end 3 between the second set screw 243 and the interior wall of the elongated body 20. The dual-means of securing the tail end 3 to the spear shaft 2 provides a failsafe in the event that either the second set screw 243 or the second fastener assembly 24 fails during implementation of the present invention.

To detach the tail end 3 from the spear shaft 2, the second set screw 243 is loosened or removed entirely. Similarly, the second compression fastener 242 is loosened or detached from the second receiving fitting 240 entirely, such that the second compression fastener 242 is able to freely slide along the tail end 3. With the second set screw 243 and the second compression fastener 242 either loosened or removed, the spear shaft 2 is pulled out of the second receiving cavity 22 and out through each of the second receiving fitting 240, the second ferrule 241, and the second compression fastener 242.

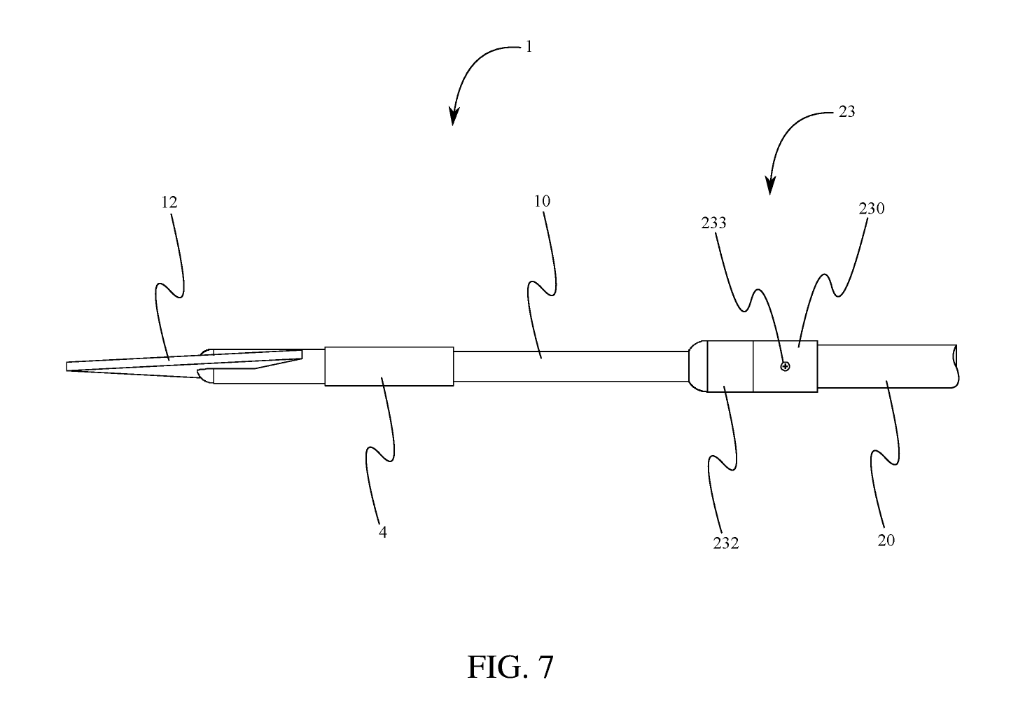

In reference to FIG. 7, the spear tip 1 provides the piercing end of the present invention, or the forward-facing end when the present invention is thrown. The spear tip 1 comprises a tip shaft 10 and a spear head 12. The tip shaft 10 provides the portion of the spear tip 1 that engages with the elongated body 20 and the first fastener assembly 23, while the spear head 12 provides the piercing end of the spear tip 1. As such, the spear head 12 is terminally connected to the tip shaft 10 in order to make first contact with the target. To attach the spear tip 1 to the spear shaft 2, the free end of the tip shaft 10 is positioned through the first fastener assembly 23 into the first receiving cavity 21, while the spear head 12 is positioned opposite the first receiving cavity 21 along the tip shaft 10. The first set screw 233 is then tightened to engage the tip shaft 10, while the first compression fastener 232 is tightened such that the first ferrule 231 is compressed to engage with the tip shaft 10. In the preferred embodiment of the present invention, the spear head 12 has a single tine. However, in other embodiments of the present invention, the spear head 12 may have more than one tine. In some embodiments of the present invention, the spear tip 1 comprises only the tip shaft 10, such that the user may attach a spear point of their own choice.

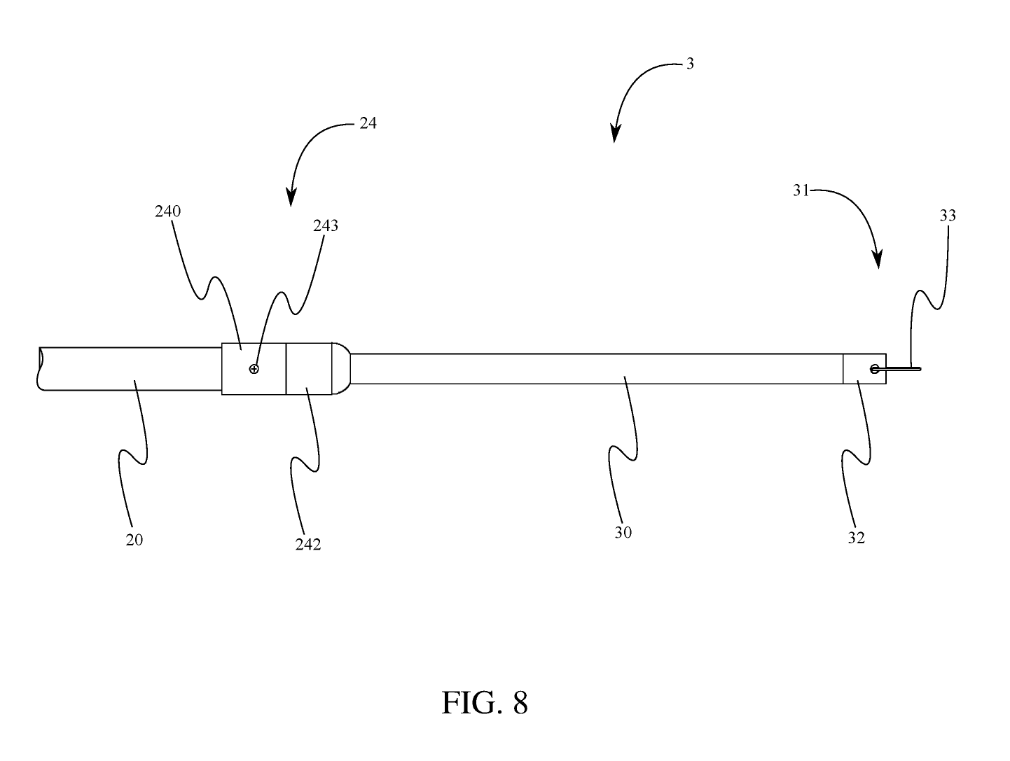

In reference to FIG. 8, the tail end 3 provides the stabilizing end of the present invention, or the rear-facing end when the present invention is thrown. The tail end 3 comprises a tail shaft 30 and a line connector 31. The tail shaft 30 provides the portion of the tail end 3 that engages with the elongated body 20 and the second fastener assembly 24, while the line connector 31 provides a means for tethering the present invention. The line connector 31 is terminally connected to the tail shaft 30, such that the tether does not interfere with throwing the present invention. To attach the tail end 3 to the spear shaft 2, the free end of the tail shaft 30 is positioned through the second fastener assembly 24 into the second receiving cavity 22, while the line connector 31 is positioned opposite the second receiving cavity 22 along the tail shaft 30. The second set screw 243 is then tightened to engage the tail shaft 30, while the second compression fastener 242 is tightened such that the second ferrule 241 is compressed to engage with the tail shaft 30.

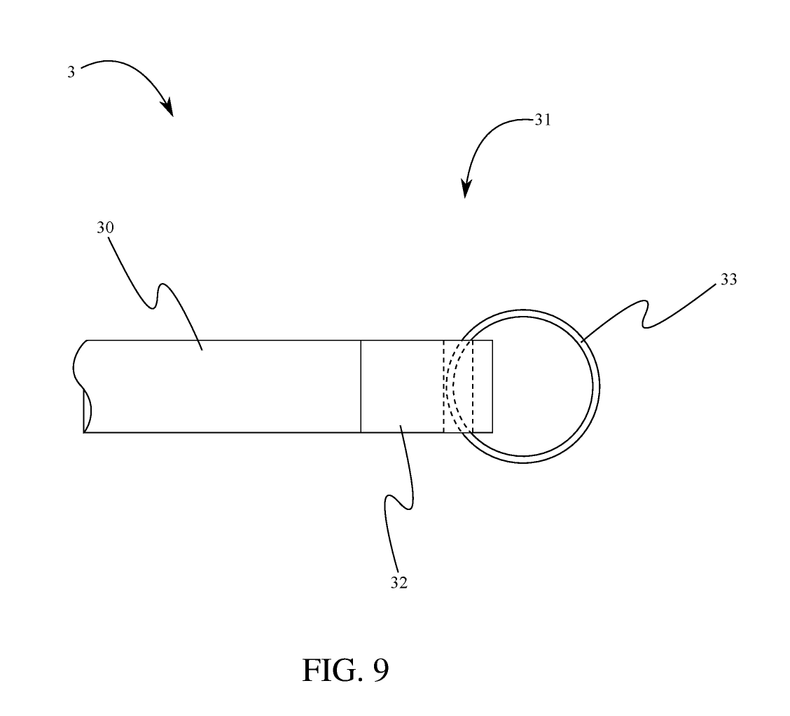

In reference to FIG. 9, in some embodiments of the present invention, the line connector 31 comprises an end cap 32 and a ring 33. The end cap 32 is connected to the tail shaft 30, while the ring 33 is coupled to the end cap 32 opposite the tail shaft 30. The ring 33 is coupled to the end cap 32 through a hole in the end cap 32. In this way, the ring 33 is able to pivot about the end cap 32. The ring 33 provides an enlarged attachment point for a tether, thus better allowing for the attachment of tethers having different diameters or for the attachment of multiple tethers. In some other embodiments of the present invention, the line connector 31 may comprise only the end cap 32, wherein a tether may be attached through the hole in the end cap 32. In yet other embodiments of the present invention, the line connector 31 may be a hole that traverses through the tail shaft 30, thus allowing a tether to directly engage with the tail shaft 30.

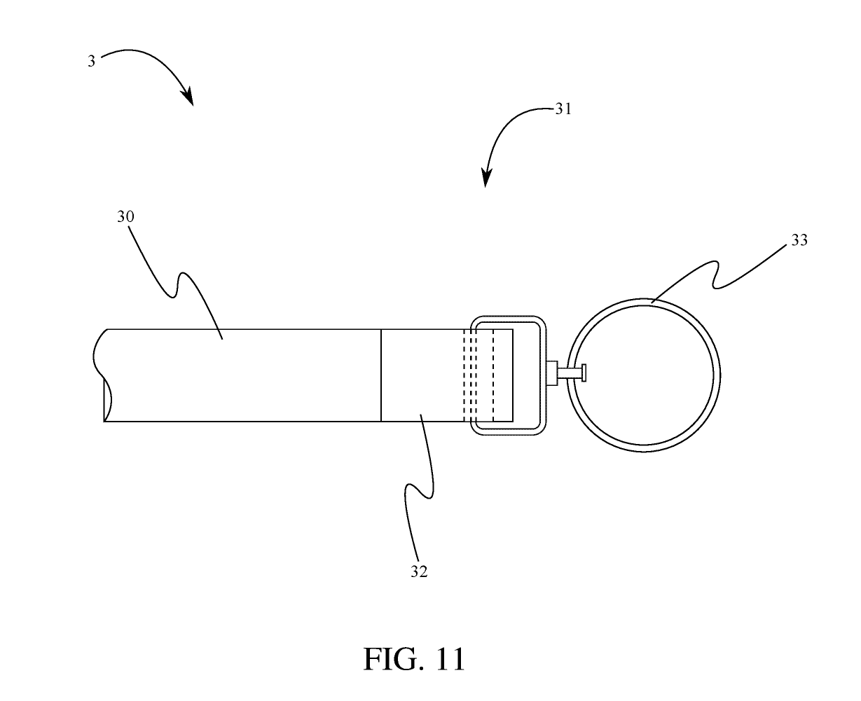

In reference to FIG. 11, in some embodiments of the present invention, the ring 33 is coupled to the end cap 32 via a swivel component. The swivel component may be connected to the end cap 32 in a fixed position or connected such that the swivel component is able to pivot about the end cap 32. The swivel component allows the ring 33 to rotate 360 degrees, thus providing uninhibited motion to the tether as the present invention is thrown. In some embodiments, the swivel component may be connected directly to the tail shaft 30.

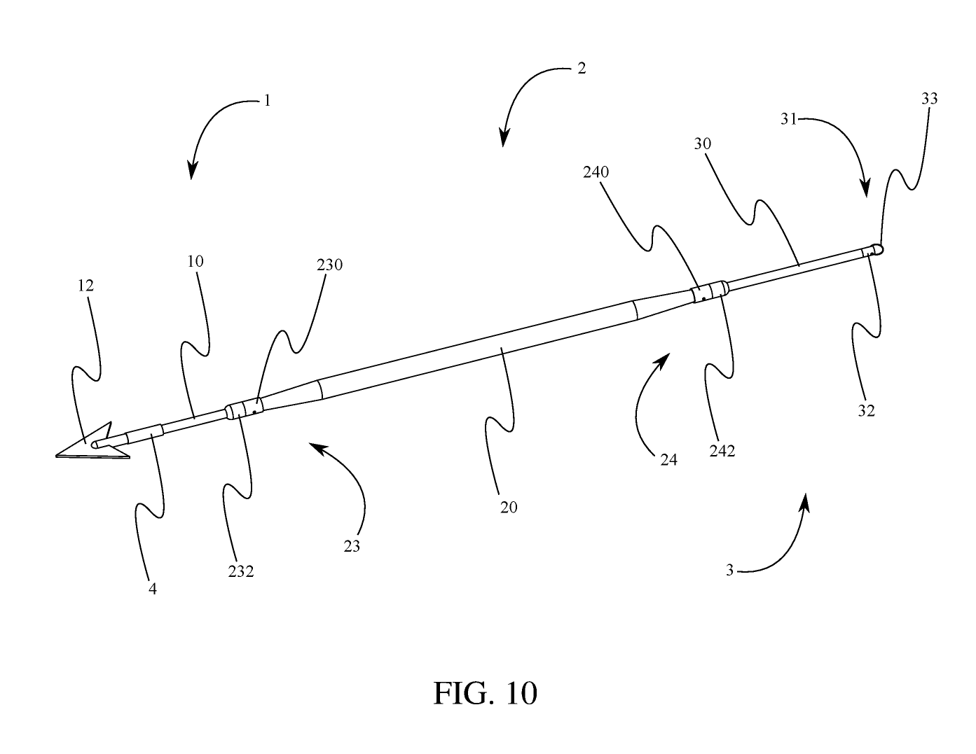

In some embodiments of the present invention, the elongated body 20 may be designed to be more aerodynamically efficient. This allows for the present invention to be thrown farther and with greater accuracy. As such, and in reference to FIG. 10, in some embodiments one end of the elongated body 20 is tapered towards the first fastener assembly 23 a, while the other end of the elongated body 20 is tapered towards the second fastener assembly 24. It is also possible for only one end of the elongated body 20 to be tapered in some embodiments.

In some embodiments of the present invention, the inner wall of the elongated body 20 that delineates the first receiving cavity 21 is threaded. Similarly, the inner wall of the elongated body 20 that delineates the second receiving cavity 22 is threaded. Furthermore, the spear tip 1 and the tail end 3 each have a threaded end for engaging with the spear shaft 2. More specifically, the free end of the tip shaft 10 (i.e. opposite the spear head 12) is threaded, while the free end of the tail shaft 30 (i.e. opposite the line connector 31) is threaded. To attach the spear tip 1 to the spear shaft 2, the tip shaft 10 is simply screwed into the first receiving cavity 21, and to remove the spear tip 1 from the spear shaft 2, the tip shaft 10 is screwed out of the first receiving cavity 21. Similarly, to attach the tail end 3 to the spear shaft 2, the tail shaft 30 is simply screwed into the second receiving cavity 22, and to remove the tail end 3 from the spear shaft 2, the tail shaft 30 is screwed out of the second receiving cavity 22.

In reference to FIG. 1, in some embodiments, the present invention further comprises a weight forward collar 4. The weight forward collar 4 is connected around the spear tip 1 and is positioned along the spear tip 1 opposite the spear shaft 2. More specifically, the weight forward collar 4 is connected around the tip shaft 10. If the spear tip 1 includes the spear head 12, then the weight forward collar 4 is positioned adjacent to the spear head 12. If the spear tip 1 does not include the spear head 12, then the weight forward collar 4 is positioned adjacent to the terminal end of the tip shaft 10, such that a portion of the tip shaft 10 is available for the user to attach their own spear point to the tip shaft 10. The weight forward collar 4 provides additional mass to the front of the present invention that in turn moves the center of gravity of the present invention closer to the spear tip 1. The additional mass of the weight forward collar 4 adds to the momentum of the present invention when thrown and allows for a more accurate throw. The weight forward collar 4 may be constructed from materials having different weights and densities, wherein the actual weight of the weight forward collar 4 may vary from one embodiment to another depending on the desired throwing qualities of the present invention.

Although the invention has been explained in relation to its preferred embodiment, it is to be understood that many other possible modifications and variations can be made without departing from the spirit and scope of the invention as hereinafter claimed.

What is claimed is:

1. A modular spear comprises:
a spear tip;
a tail end;
a spear shaft comprising an elongated body, a first receiving cavity, a second receiving cavity, a first fastener assembly, and a second fastener assembly;
the first receiving cavity and the second receiving cavity terminally traversing into the elongated body;
the first receiving cavity and the second receiving cavity being positioned opposite each other along the elongated body;
the first fastener assembly and the second fastener assembly being terminally connected to the elongated body;
the first fastener assembly being positioned about the first receiving cavity;
the second fastener assembly being positioned about the second receiving cavity;
the spear tip being positioned through the first fastener assembly into the first receiving cavity; and
the tail end being positioned through the second fastener assembly and into the second receiving cavity.

2. The modular spear as claimed in claim 1 comprises:
the first fastener assembly comprising a first compression fastener, a first ferrule, and a first receiving fitting;
the first receiving fitting being connected around the elongated body;
the first compression fastener being threadedly engaged with the first receiving fitting, opposite the second fastener assembly; and
the first ferrule being positioned in between the first receiving fitting and the first compression fastener.

3. The modular spear as claimed in claim 2 comprises:
the spear tip traversing through the first compression fastener, the first ferrule, and the first receiving fitting.

4. The modular spear as claimed in claim 1 comprises:
the first fastener assembly comprising a first receiving fitting and a first set screw;
the first receiving fitting being connected to the elongated body; and
the first set screw traversing through the first receiving fitting and the elongated body.

5. The modular spear as claimed in claim 4 comprises:
the first set screw being engaged with the spear tip.

6. The modular spear as claimed in claim 1 comprises:
the second fastener assembly comprising a second compression fastener, a second ferrule, and a second receiving fitting;
the second receiving fitting being connected around the elongated body;
the second compression fastener being threadedly engaged with the second receiving fitting, opposite the first fastener assembly; and
the second ferrule being positioned in between the second receiving fitting and the second compression fastener.

7. The modular spear as claimed in claim 6 comprises:
the spear tip traversing through the second compression fastener, the second ferrule, and the second receiving fitting.

8. The modular spear as claimed in claim 1 comprises:
the second fastener assembly comprising a second receiving fitting and a second set screw;
the second receiving fitting being connected to the elongated body; and
the second set screw traversing through the second receiving fitting and the elongated body.

9. The modular spear as claimed in claim 8 comprises:
the second set screw being engaged with the spear tip.

10. The modular spear as claimed in claim 1 comprises:
the spear tip comprising a tip shaft and a spear head; and
the spear head being terminally connected to the tip shaft.

11. The modular spear as claimed in claim 10 comprises:
the tip shaft being positioned through the first fastener assembly into the first receiving cavity; and
the spear head being positioned opposite the first receiving cavity along the tip shaft.

12. The modular spear as claimed in claim 1 comprises:
the tail end comprising a tail shaft and a line connector; and
the line connector being terminally connected to the tail shaft.

13. The modular spear as claimed in claim 12 comprises:
the tail shaft being positioned through the second fastener assembly into the second receiving cavity; and
the line connector being positioned opposite the second receiving cavity along the tip shaft.

14. The modular spear as claimed in claim 12 comprises:
the line connector comprising an end cap and a ring;
the end cap being connected to the tail shaft; and
the ring being coupled to the end cap opposite the tail shaft.

15. The modular spear as claimed in claim 1, wherein the elongated body is tapered towards the first fastener assembly.

16. The modular spear as claimed in claim 1, wherein the elongated body is tapered towards the second fastener assembly.

17. The modular spear as claimed in claim 1 comprises:
a weight forward collar;
the weight forward collar being connected around the spear tip; and
the weight forward collar being positioned along the spear tip opposite the spear shaft.

18. The modular spear as claimed in claim 17 comprises:
the spear tip comprising a tip shaft and a spear head;
the spear head being terminally connected to the tip shaft;
the weight forward collar being connected around the tip shaft; and
the weight forward collar being positioned adjacent to the spear head.
